(19) United States
(12) Patent Application Publication
(10) Pub. No.: US 2024/0421536 A1
(43) Pub. Date: Dec. 19, 2024

(54) WIRE END CONNECTOR

(71) Applicant: BIZLINK INTERNATIONAL CORP., New Taipei City (TW)

(72) Inventors: Jui-Hung CHIEN, New Taipei City (TW); Yi-Hsing CHUNG, New Taipei City (TW)

(21) Appl. No.: 18/739,298

(22) Filed: Jun. 10, 2024

(30) Foreign Application Priority Data
Jun. 13, 2023 (TW) 112122078

(51) Int. Cl. H01R 13/627

(52) U.S. Cl. CPC H01R 13/6273

(57) ABSTRACT

A wire end connector includes a base, an elastic fastener and a pulling tab. The base has an upper surface and a bridge structure disposed on the upper surface. The bridge structure and the upper surface define a tab channel therebetween. The elastic fastener includes two latches and a connecting rod connected between the latches. The latches are connected with the upper surface. The connecting rod has a tab hole portion. The pulling tab wraps around the tab hole portion of the connecting rod and extends outwards through the tab channel. A first width of the pulling tab at the tab hole portion is larger than a second width of the pulling tab at the tab channel.

### RELATED APPLICATIONS

This application claims priority to Taiwanese Application Serial Number 112122078, filed Jun. 13, 2023, which is herein incorporated by reference in its entirety.

### BACKGROUND

### Technical Field

The present disclosure relates to connectors. More particularly, the present disclosure relates to pulling-tab type wire end high speed connectors.

### Description of Related Art

As the rhythm of lives today has been speeding up, the demand of people for electronic devices is also increasing. To cope with the huge consumer market, apart from improving the efficacy and performance of their own products, various manufacturers are also working hard to enhance the reliability and stability of their electronic equipment in order to strengthen the market competitiveness of their brands.

Taking wire end connectors as an example. The measure to make the connection between electronic devices through wire end connectors more reliable and easier, while extending the service life of the connectors, is undoubtedly an important issue to which the industry highly concerns.

### SUMMARY

A technical aspect of the present disclosure is to provide a wire end connector, which can effectively enhance the reliability and stability of detachment from a slot structure of an electronic equipment.

According to an embodiment of the present disclosure, a wire end connector includes a base, an elastic fastener and a pulling tab. The base has an upper surface and a bridge structure disposed on the upper surface. The bridge structure and the upper surface define a tab channel therebetween. The elastic fastener includes two latches and a connecting rod connected between the latches. The latches are connected with the upper surface. The connecting rod has a tab hole portion. The pulling tab wraps around the tab hole portion of the connecting rod and extends outwards through the tab channel. A first width of the pulling tab at the tab hole portion is larger than a second width of the pulling tab at the tab channel.

In one or more embodiments of the present disclosure, the latches are symmetrical to each other and spaced apart from each other by a distance. The first width of the pulling tab at the tab hole portion is equal to 50%-100% of the distance.

In one or more embodiments of the present disclosure, the first width of the pulling tab at the tab hole portion is a horizontal distance between two farthest lateral edges of the pulling tab.

In one or more embodiments of the present disclosure, the tab channel has a third width. The third width is larger than the second width and less than the first width.

In one or more embodiments of the present disclosure, each of the latches includes a fixing portion and an arm portion. The fixing portion is connected with the upper surface. The arm portion has a first end and a second end opposite to the first end. The first end is elastically connected with the fixing portion. The second end is connected with the connecting rod. The arm portion is inclined to the fixing portion by an angle.

In one or more embodiments of the present disclosure, the elastic fastener further includes two snapping portions. The snapping portions are respectively disposed on and protruded from a corresponding one of the arm portions. Each of the snapping portions is shaped as a hook.

In one or more embodiments of the present disclosure, the pulling tab further includes a first portion, a second portion and a third portion. The first portion has the first width. The second portion has the second width. The second portion is connected between the first portion and the third portion. The third portion has a fourth width. The fourth width is larger than the second width.

In one or more embodiments of the present disclosure, the second portion includes a first layer and a second layer attached to the first layer. The third portion includes a third layer and a fourth layer attached to the third layer. The first layer is connected between the first portion and the third layer. The second layer is connected between the first portion and the fourth layer.

In one or more embodiments of the present disclosure, the first portion surrounds and defines a through hole therein. The connecting rod at least partially penetrates through the through hole.

In one or more embodiments of the present disclosure, the wire end connector includes at least one electric board and a plurality of cables. The electric board includes a main board and a plurality of electric contacts. The electric contacts are disposed on the main board. The main board is at least partially disposed inside the base. The cables are electrically connected with the main board and at least partially disposed inside the base.

According to an embodiment of the present disclosure, the wire end connector includes a base, an elastic fastener and a pulling tab. The base has an upper surface and a bridge structure disposed on the upper surface. The bridge structure and the upper surface define a tab channel therebetween. The elastic fastener includes two latches and a connecting rod connected between the latches. The latches are connected with the upper surface and spaced apart from each other by a first distance. The pulling tab wraps around the connecting rod and penetrates outwards through the tab channel. A portion of the pulling tab wrapping around the connecting rod is at least partially located between the latches and spaced apart from each of the latches by a second distance. The second distance is equal to 0%-25% of the first distance.

In one or more embodiments of the present disclosure, the portion of the pulling tab wrapping around the connecting rod has a first width. A sum of the first width and two of the second distances is equal to the first distance.

In one or more embodiments of the present disclosure, a portion of the pulling tab penetrating through the tab channel has a second width. The second width is less than the first width.

In one or more embodiments of the present disclosure, the tab channel has a third width. The third width is larger than the second width and less than the first width.

In one or more embodiments of the present disclosure, the pulling tab further includes a first portion, a second portion and a third portion. The first portion has the first width. The second portion has the second width. The second portion is connected between the first portion and the third portion. The third portion has a fourth width. The fourth width is larger than the second width.

In one or more embodiments of the present disclosure, the second portion includes a first layer and a second layer attached to the first layer. The third portion includes a third layer and a fourth layer attached to the third layer. The first layer is connected between the first portion and the third layer. The second layer is connected between the first portion and the fourth layer. The first portion surrounds and defines a through hole therein. The connecting rod at least partially penetrates through the through hole.

In one or more embodiments of the present disclosure, each of the latches includes a fixing portion and an arm portion. The fixing portion is connected with the upper surface. The arm portion has a first end and a second end opposite to the first end. The first end is elastically connected with the fixing portion. The second end is connected with the connecting rod. The arm portion is inclined to the fixing portion by an angle.

In one or more embodiments of the present disclosure, the elastic fastener further includes two snapping portions. The snapping portions are respectively disposed on and protruded from a corresponding one of the arm portions. Each of the snapping portions is shaped as a hook.

In one or more embodiments of the present disclosure, the connecting rod has a tab hole portion. The pulling tab at least partially penetrates through the tab hole portion to wrap around the connecting rod.

The above-mentioned embodiments of the present disclosure have at least the following advantages: since the first width of the pulling tab at the tab hole portion is larger than the second width of the pulling tab at the tab channel, and the first width of the pulling tab at the tab hole portion is equal to 50%-100% of the distance between the two latches, when a user tightly grips the third portion of the pulling tab to pull the pulling tab, the two latches are unlikely to be deformed unevenly due to an uneven application of force, thus effectively enhancing the reliability and stability of detachment of the wire end connector from the slot structure of the electronic equipment.

### BRIEF DESCRIPTION OF THE DRAWINGS

The disclosure can be more fully understood by reading the following detailed description of the embodiments, with reference made to the accompanying drawings as follows:

FIG. 1 is a schematic view of a wire end connector according to an embodiment of the present disclosure;

FIG. 2 is a schematic view of the wire end connector of FIG. 1 from another angle;

FIG. 3 is a top view of the wire end connector of FIGS. 1-2;

FIG. 4 is a sectional view along the sectional line A-A of FIG. 3;

FIG. 5 is a schematic view of the elastic fastener and the pulling tab of FIGS. 1-3;

FIG. 6 is a sectional view along the sectional line B-B of FIG. 3, in which the wire end connector is at least partially located inside a slot structure of an electronic equipment and the pulling tab is not yet pulled; and

FIG. 7 is a sectional view along the sectional line B-B of FIG. 3, in which the pulling tab is pulled and the snapping portion is detached from an opening of a slot structure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

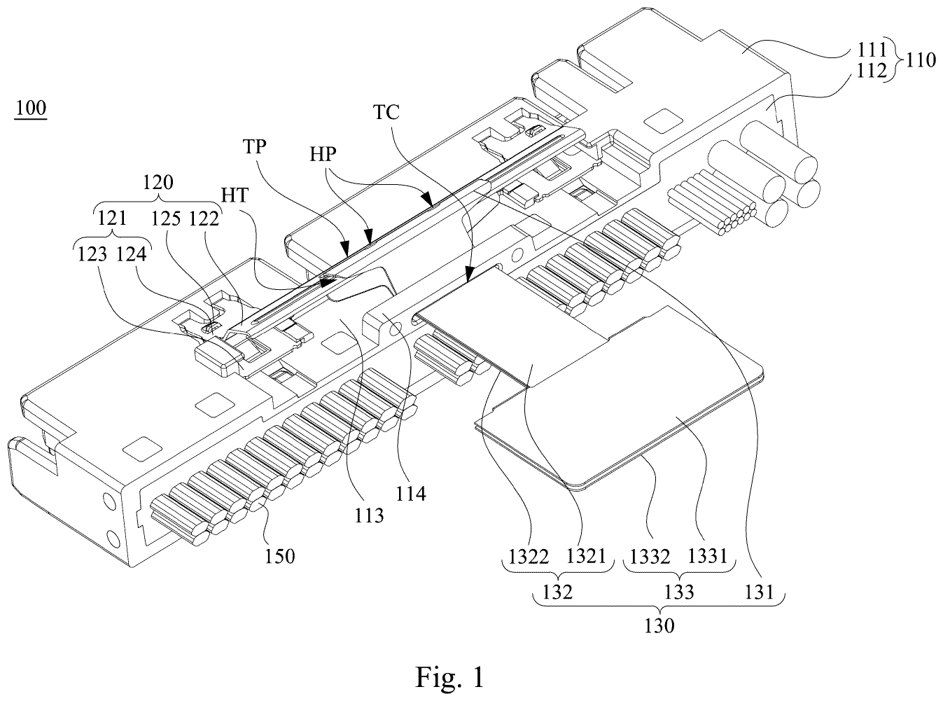

FIGS. 1-7 are drawn according to the actual scale. For the sake of concise description in this specification, the scales of the elements are not listed one by one. However, the scale and position of each element should be regarded as part of the scope of this specification.

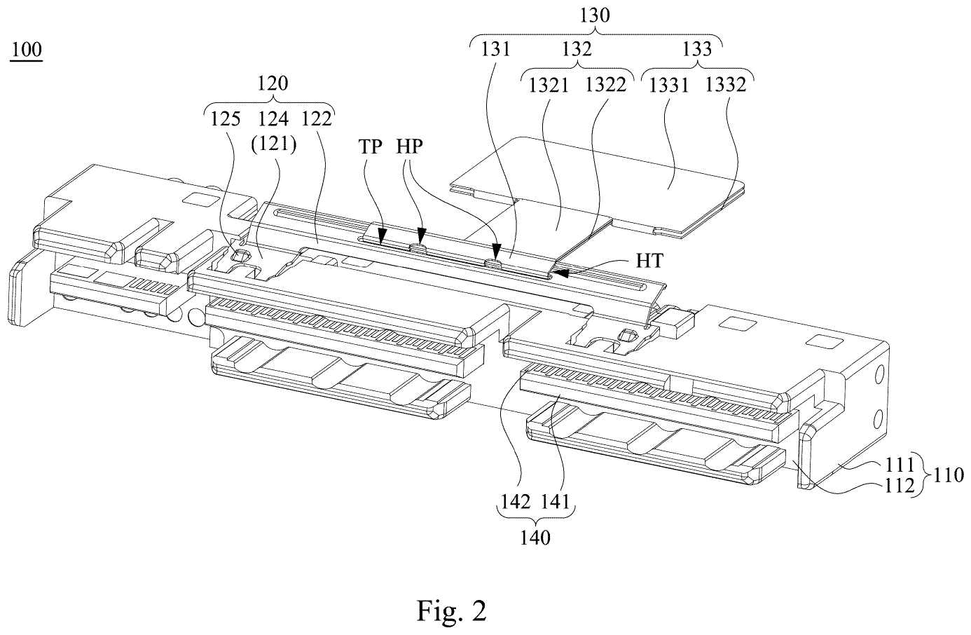

Reference is made to FIGS. 1-2. FIG. 1 is a schematic view of a wire end connector 100 according to an embodiment of the present disclosure. FIG. 2 is a schematic view of the wire end connector 100 of FIG. 1 from another angle. In this embodiment, as shown in FIGS. 1-2, a wire end connector 100 is disclosed. The wire end connector 100 includes a base 110, an elastic fastener 120 and a pulling tab 130. The base 110 includes an outer mold 111 and an inner mold 112. The inner mold 112 is disposed inside the outer mold 111. The outer mold 111 has an upper surface 113 and a bridge structure 114 disposed on the upper surface 113. The bridge structure 114 and the upper surface 113 define a tab channel TC therebetween. The elastic fastener 120 includes two latches 121 and a connecting rod 122 connected between the latches 121. The latches 121 are connected with the upper surface 113 of the outer mold 111. The connecting rod 122 has a tab hole portion TP. The pulling tab 130 wraps around the tab hole portion TP of the connecting rod 122 and extends outwards through the tab channel TC.

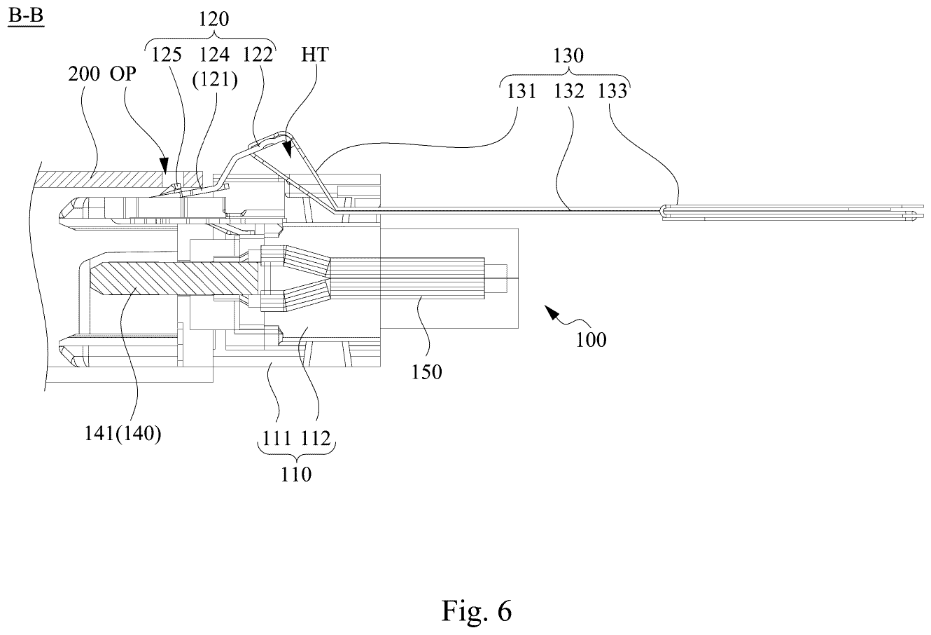

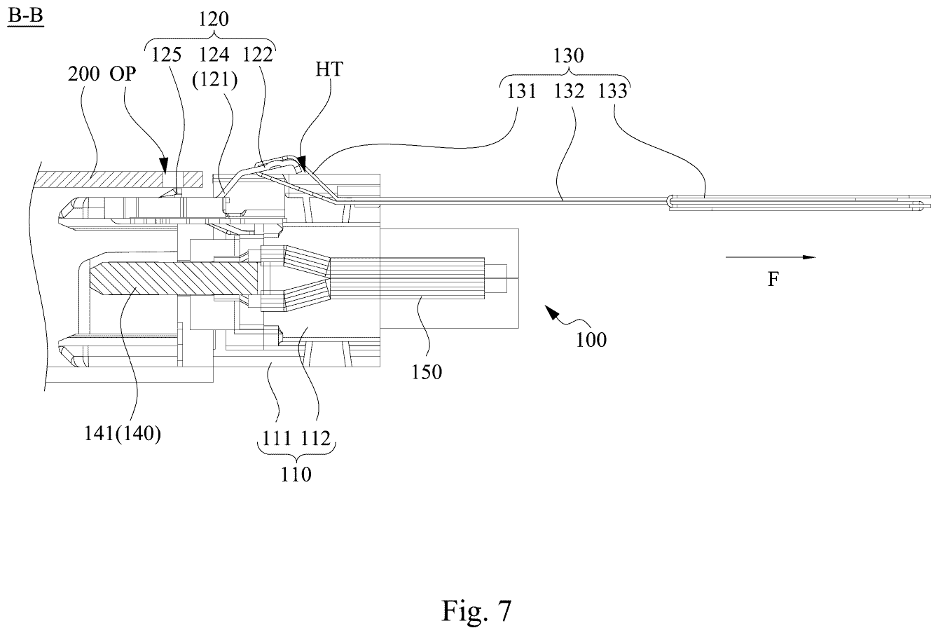

Moreover, as shown in FIGS. 1-2, the wire end connector 100 includes at least one electric board 140 (please see FIG. 2 for the electric board 140) and a plurality of cables 150 (please see FIG. 1 for the cables 150). The electric board 140 includes a main board 141 and a plurality of electric contacts 142. The electric contacts 142 are disposed on the main board 141. The electric contacts 142 are configured to electrically connect with another electronic equipment (not shown). The main board 141 and the cables 150 are at least partially disposed inside the base 110. To be more specific, the main board 141 and the cables 150 are electrically connected with each other and at least partially fixed inside the inner mold 112 of the base 110 (please see FIGS. 6-7). In practical applications, when the wire end connector 100 is connected with another electronic equipment, the base 110 of the wire end connector 100 is at least partially inserted into a slot structure 200 (please see FIGS. 6-7 for the slot structure 200) of the electronic equipment, and the electric contacts 142 are electrically connected with a conductive element of the electronic equipment.

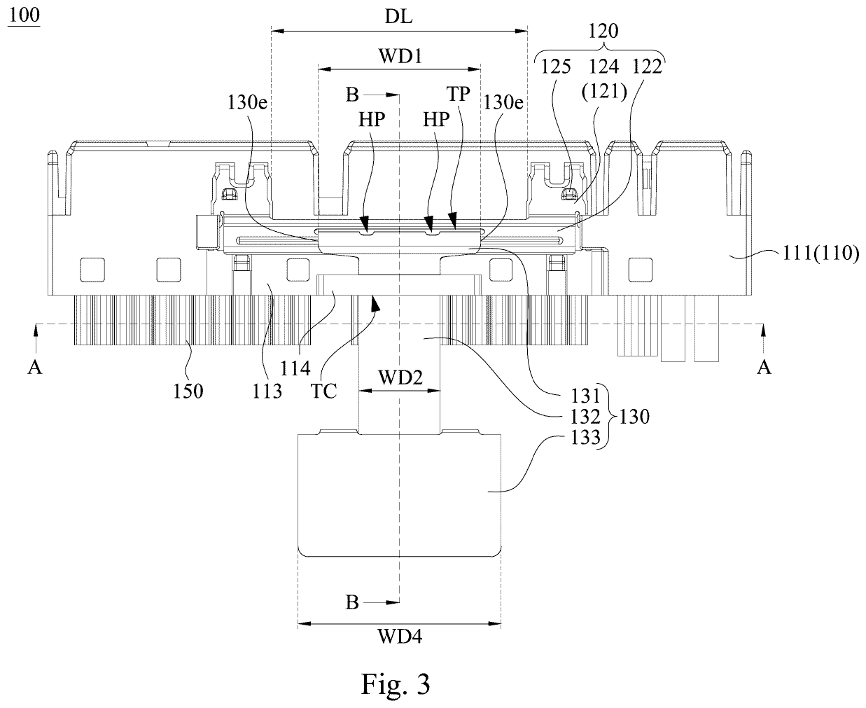

Reference is made to FIG. 3. FIG. 3 is a top view of the wire end connector 100 of FIGS. 1-2. It is worth to note that, as shown in FIG. 3, a first width WD1 of the pulling tab 130 at the tab hole portion TP is larger than a second width WD2 of the pulling tab 130 at the tab channel TC. To be more specific, the two latches 121 are symmetrical to each other and spaced apart from each other by a distance DL. The first width WD1 of the pulling tab 130 at the tab hole portion TP is equal to 50%-100% of the distance DL. For example, the ratio of the first width WD1 to the distance DL can be 50%, 55%, 60%, 65%, 70%, 75%, 80%, 85%, 90%, 95%, 100% etc. In practice, the first width WD1 of the pulling tab 130 at the tab hole portion TP is a horizontal distance between two farthest lateral edges 130e of the pulling tab 130. Moreover, the pulling tab 130 has at least two pulling tab holes HP. The two pulling tab holes HP are located between the two lateral edges 130e. According to the actual situation, a dimension of each of the pulling tab holes HP can be increased or decreased.

In another embodiment, the tab hole portion TP of the connecting rod 122 has at least two through holes (not shown), and these at least two through holes are spaced apart from each other. For example, when the quantity of the through holes of the tab hole portion TP is two, these two through holes respectively allow a portion of the pulling tab 130 to penetrate through, and these two through holes are at least partially located between the two farthest lateral edges 130e of the pulling tab 130. In other words, the pulling tab 130 wraps around the connecting rod 122 at the positions of these two through holes, and the portions of the pulling tab 130 wrapping around these two through holes of the connecting rod 122 are two outer parts of the pulling tab 130. Moreover, the pulling tab 130 does not wrap around the connecting rod 122 at the position between these two through holes.

Furthermore, as shown in FIGS. 1-3, the pulling tab 130 further includes a first portion 131, a second portion 132 and a third portion 133. The second portion 132 is connected between the first portion 131 and the third portion 133. The first portion 131 of the pulling tab 130 wraps around the tab hole portion TP of the connecting rod 122. The first portion 131 has the first width WD1 mentioned above. The second portion 132 has the second width WD2 mentioned above. The third portion 133 has a fourth width WD4. The fourth width WD4 is larger than the second width WD2. In practical applications, the third portion 133 of the pulling tab 130 can be tightly gripped by the fingers of a user for pulling the pulling tab 130.

In practical applications, as shown in FIGS. 1-2, the second portion 132 of the pulling tab 130 includes a first layer 1321 and a second layer 1322 attached to the first layer 1321. The third portion 133 includes a third layer 1331 and a fourth layer 1332 attached to the third layer 1331. The first layer 1321 is connected between the first portion 131 and the third layer 1331. The second layer 1322 is connected between the first portion 131 and the fourth layer 1332. In other words, the pulling tab 130 is folded from the third layer 1331, the first layer 1321, the first portion 131, the second layer 1322 and the fourth layer 1332 which are sequentially connected.

In addition, as shown in FIGS. 1-2, the first portion 131 of the pulling tab 130 surrounds and defines a through hole HT therein. The connecting rod 122 of the elastic fastener 120 at least partially penetrates through the through hole HT surrounded and formed by the first portion 131 of the pulling tab 130. Thus, the first portion 131 of the pulling tab 130 can be securely connected to the connecting rod 122.

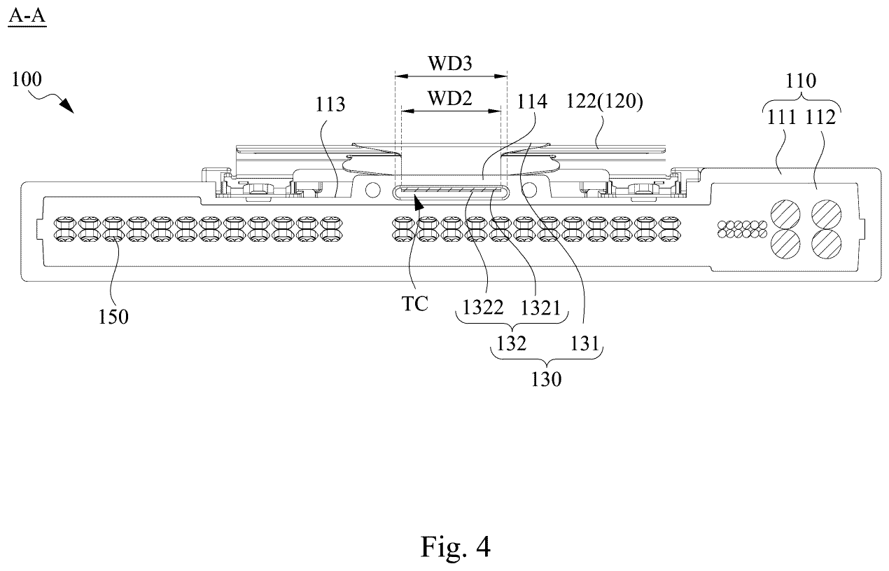

Reference is made to FIG. 4. FIG. 4 is a sectional view along the sectional line A-A of FIG. 3. In this embodiment, as shown in FIG. 4, the tab channel TC has a third width WD3. The third width WD3 is larger than the second width WD2 of the pulling tab 130 and less than the first width WD1 and the fourth width WD4 (please see FIG. 3 for the first width WD1 and the fourth width WD4). This means, apart from the second portion 132, the first portion 131 and the third portion 133 of the pulling tab 130 are respectively folded into a narrower shape first in order to penetrate through the tab channel TC.

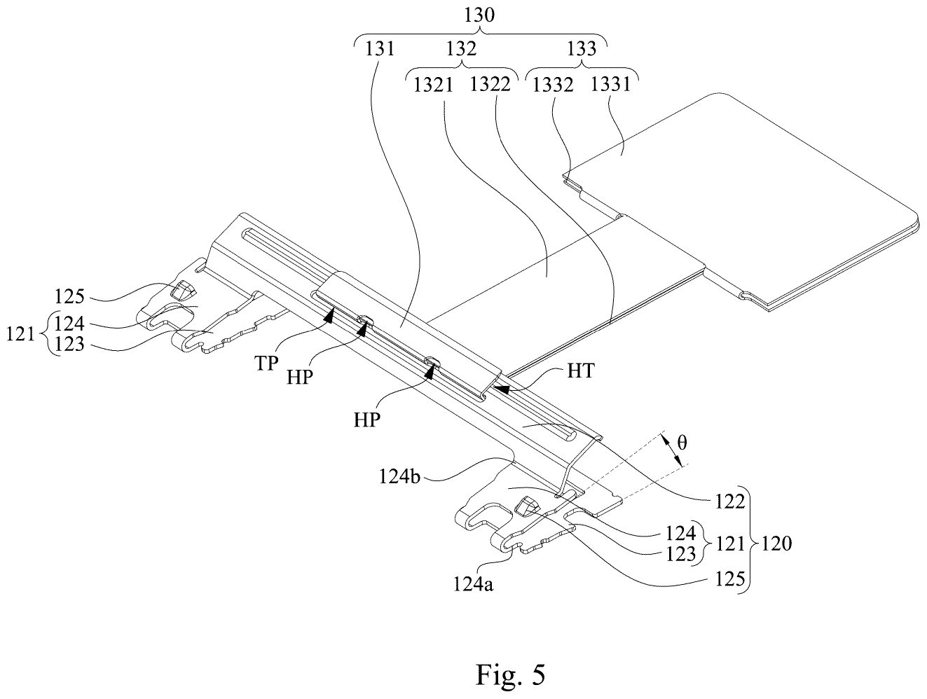

Reference is made to FIG. 5. FIG. 5 is a schematic view of the elastic fastener 120 and the pulling tab 130 of FIGS. 1-3. In this embodiment, as shown in FIG. 5, each of the two latches 121 includes a fixing portion 123 and an arm portion 124. The fixing portion 123 is connected with the upper surface 113 of the outer mold 111 (please see FIGS. 1-4 for the outer mold 111). The arm portion 124 has a first end 124a and a second end 124b opposite to the first end 124a. The first end 124a is elastically connected with the fixing portion 123. The second end 124b is connected with the connecting rod 122. The arm portion 124 is inclined to the fixing portion 123 by an angle θ. When the arm portion 124 is elastically deformed relative to the fixing portion 123, the angle θ correspondingly varies.

In addition, as shown in FIGS. 1-3 and 5, the elastic fastener 120 further includes two snapping portions 125. The two snapping portions 125 are respectively disposed on and protruded from a corresponding one of the arm portions 124. Each of the two snapping portions 125 is shaped as a hook.

Reference is made to FIGS. 6-7. FIG. 6 is a sectional view along the sectional line B-B of FIG. 3, in which the wire end connector 100 is at least partially located inside a slot structure 200 of an electronic equipment and the pulling tab 130 is not yet pulled. FIG. 7 is a sectional view along the sectional line B-B of FIG. 3, in which the pulling tab 130 is pulled and the snapping portion 125 is detached from an opening OP of a slot structure 200. In this embodiment, as shown in FIG. 6, when the base 110 of the wire end connector 100 is at least partially inserted into a slot structure 200 of an electronic equipment, before a user tightly grips the third portion 133 of the pulling tab 130 to pull the pulling tab 130, the snapping portions 125 of the elastic fastener 120 are respectively at least partially snapped with the slot structure 200 at an opening OP of the slot structure 200, such that the position of the wire end connector 100 relative to the slot structure 200 is secured, and the wire end connector 100 is prevented from detaching from the slot structure 200. However, as shown in FIG. 7, when a user (not shown) tightly grips the third portion 133 of the pulling tab 130 to pull the pulling tab 130 by a force F, the connecting rod 122 wrapped by the first portion 131 of the pulling tab 130 at the tab hole portion TP is driven, such that the arm portion 124 of each of the latches 121 is elastically deformed relative to the corresponding one of the fixing portions 123, and the snapping portion 125 disposed on each of the arm portions 124 leaves from the opening OP of the slot structure 200 due to the elastic deformation of the arm portions 124. At this point, the snapping portions 125 are no longer snapped with the slot structure 200. Thus, the user can detach the wire end connector 100 from the slot structure 200 of the electronic equipment in a simple and easy manner.

It is worth to note that, since the first width WD1 of the pulling tab 130 at the tab hole portion TP is larger than the second width WD2 of the pulling tab 130 at the tab channel TC, and the first width WD1 of the pulling tab 130 at the tab hole portion TP is equal to 50%-100% of the distance DL between the two latches 121, when a user tightly grips the third portion 133 of the pulling tab 130 to pull the pulling tab 130, the two latches 121 are unlikely to be deformed unevenly due to an uneven application of force, which may probably cause one of the two snapping portions 125 failing to entirely leave from the opening OP of the slot structure 200. In other words, the ratio of the first width WD1 of the pulling tab 130 to the distance DL between the two latches 121 can effectively enhance the reliability and stability of detachment of the wire end connector 100 from the slot structure 200 of the electronic equipment.

In conclusion, the aforementioned embodiments of the present disclosure have at least the following advantages: since the first width of the pulling tab at the tab hole portion is larger than the second width of the pulling tab at the tab channel, and the first width of the pulling tab at the tab hole portion is equal to 50%-100% of the distance between the two latches, when a user tightly grips the third portion of the pulling tab to pull the pulling tab, the two latches are unlikely to be deformed unevenly due to an uneven application of force, thus effectively enhancing the reliability and stability of detachment of the wire end connector from the slot structure of the electronic equipment.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A wire end connector, comprising:
a base having an upper surface and a bridge structure disposed on the upper surface, the bridge structure and the upper surface defining a tab channel therebetween;
an elastic fastener comprising two latches and a connecting rod connected between the latches, the latches being connected with the upper surface, the connecting rod having a tab hole portion; and
a pulling tab wrapping around the tab hole portion of the connecting rod and extending outwards through the tab channel, wherein a first width of the pulling tab at the tab hole portion is larger than a second width of the pulling tab at the tab channel.

2. The wire end connector of claim 1, wherein the latches are symmetrical to each other and spaced apart from each other by a distance, the first width of the pulling tab at the tab hole portion is equal to 50%-100% of the distance.

3. The wire end connector of claim 1, wherein the first width of the pulling tab at the tab hole portion is a horizontal distance between two farthest lateral edges of the pulling tab.

4. The wire end connector of claim 1, wherein the tab channel has a third width, the third width is larger than the second width and less than the first width.

5. The wire end connector of claim 1, wherein each of the latches comprises:
a fixing portion connected with the upper surface; and
an arm portion having a first end and a second end opposite to the first end, the first end is elastically connected with the fixing portion, the second end is connected with the connecting rod, the arm portion is inclined to the fixing portion by an angle.

6. The wire end connector of claim 5, wherein the elastic fastener further comprises:
two snapping portions respectively disposed on and protruded from a corresponding one of the arm portions, each of the snapping portions is shaped as a hook.

7. The wire end connector of claim 1, wherein the pulling tab further comprises:
a first portion having the first width;
a second portion having the second width; and
a third portion, the second portion is connected between the first portion and the third portion, the third portion has a fourth width, the fourth width is larger than the second width.

8. The wire end connector of claim 7, wherein the second portion comprises a first layer and a second layer attached to the first layer, the third portion comprises a third layer and a fourth layer attached to the third layer, the first layer is connected between the first portion and the third layer, the second layer is connected between the first portion and the fourth layer.

9. The wire end connector of claim 7, wherein the first portion surrounds and defines a through hole therein, the connecting rod at least partially penetrates through the through hole.

10. The wire end connector of claim 1, further comprising:
at least one electric board comprising a main board and a plurality of electric contacts, the electric contacts being disposed on the main board, the main board being at least partially disposed inside the base; and
a plurality of cables electrically connected with the main board and at least partially disposed inside the base.

11. A wire end connector, comprising:
a base having an upper surface and a bridge structure disposed on the upper surface, the bridge structure and the upper surface defining a tab channel therebetween;
an elastic fastener comprising two latches and a connecting rod connected between the latches, the latches being connected with the upper surface and spaced apart from each other by a first distance; and
a pulling tab wrapping around the connecting rod and penetrating outwards through the tab channel, a portion of the pulling tab wrapping around the connecting rod being at least partially located between the latches and spaced apart from each of the latches by a second distance,
wherein the second distance is equal to 0%-25% of the first distance.

12. The wire end connector of claim 11, wherein the portion of the pulling tab wrapping around the connecting rod has a first width, a sum of the first width and two of the second distances is equal to the first distance.

13. The wire end connector of claim 12, wherein a portion of the pulling tab penetrating through the tab channel has a second width, the second width is less than the first width.

14. The wire end connector of claim 13, wherein the tab channel has a third width, the third width is larger than the second width and less than the first width.

15. The wire end connector of claim 13, wherein the pulling tab further comprises:
a first portion having the first width;
a second portion having the second width; and
a third portion, the second portion is connected between the first portion and the third portion, the third portion has a fourth width, the fourth width is larger than the second width.

16. The wire end connector of claim 15, wherein the second portion comprises a first layer and a second layer attached to the first layer, the third portion comprises a third layer and a fourth layer attached to the third layer, the first layer is connected between the first portion and the third layer, the second layer is connected between the first portion and the fourth layer, the first portion surrounds and defines a through hole therein, the connecting rod at least partially penetrates through the through hole.

17. The wire end connector of claim 11, wherein each of the latches comprises:
a fixing portion connected with the upper surface; and
an arm portion having a first end and a second end opposite to the first end, the first end is elastically connected with the fixing portion, the second end is connected with the connecting rod, the arm portion is inclined to the fixing portion by an angle.

18. The wire end connector of claim 17, wherein the elastic fastener further comprises:
two snapping portions respectively disposed on and protruded from a corresponding one of the arm portions, each of the snapping portions is shaped as a hook.

19. The wire end connector of claim 11, wherein the connecting rod having a tab hole portion, the pulling tab at least partially penetrates through the tab hole portion to wrap around the connecting rod.
